(19) United States
(12) Patent Application Publication
(10) Pub. No.: US 2026/0058056 A1
(43) Pub. Date: Feb. 26, 2026

(54) MULTILAYER CERAMIC CAPACITOR

(71) Applicant: Murata Manufacturing Co., Ltd., Nagaokakyo-shi (JP)

(72) Inventor: Hiroyasu YOSHIDA, Nagaokakyo-shi (JP)

(21) Appl. No.: 19/374,419

(22) Filed: Oct. 30, 2025

Related U.S. Application Data
(63) Continuation of application No. PCT/JP2024/023833, filed on Jul. 1, 2024.

(30) Foreign Application Priority Data
Sep. 29, 2023 (JP) 2023-169783

(51) Int. Cl. H01G 2/00; H01G 4/12; H01G 4/30

(52) U.S. Cl. CPC H01G 2/00; H01G 4/1209; H01G 4/30

(57) ABSTRACT

A multilayer ceramic capacitor includes a multilayer body including an active portion and inactive portions, side margin portions, a first terminal electrode, and a second terminal electrode. The side margin portions include a first segregate including silicon as a main ingredient and having a longest dimension of about 10 nm or greater and about 50 nm or smaller, and second segregates including silicon as a main ingredient and having a longest dimension of about 1 μm or greater.

### CROSS REFERENCE TO RELATED APPLICATIONS

This application claims the benefit of priority to Japanese Patent Application No. 2023-169783 filed on Sep. 29, 2023 and is a Continuation Application of PCT Application No. PCT/JP2024/023833 filed on Jul. 1, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Characteristics demanded of multilayer ceramic capacitors are a decrease in thickness and an increase in capacitance. To decrease the thickness of a multilayer ceramic capacitor, abnormal grain growth in a firing step needs to be reduced. Lowering the firing temperature in order to reduce abnormal grain growth may cause insufficient sintering.

There is a technique where in order to sinter a ceramic, silicon dioxide is added to a dielectric material to densify a portion formed of a dielectric and located on or near the outer periphery (hereinafter referred to as an outer peripheral portion) of a multilayer ceramic capacitor. Japanese Unexamined Patent Application Publication No. 2022-084913 discloses a technique of adding silicon dioxide to a dielectric material. Also, the outer peripheral portion is formed by, depending on the configuration of the multilayer ceramic capacitor, a side margin portion, an inactive portion, an outer layer portion, or the like.

Lowering the firing temperature or adding an additive such as silicon dioxide to a dielectric material may lower the mechanical strength of the multilayer ceramic capacitor. When the mechanical strength lowers, ridgeline portions of the multilayer ceramic capacitor may chip or crack while the multilayer ceramic capacitor is being handled.

### SUMMARY OF THE INVENTION

Example embodiments of the present invention provide multilayer ceramic capacitors each with sufficient mechanical strength.

A multilayer ceramic capacitor includes a multilayer body including a first internal electrode layer and a second internal electrode layer alternately laminated with a dielectric layer including a ceramic dielectric interposed therebetween, an active portion including a first active-portion main surface in a lamination direction, a second active-portion main surface opposite from the first active-portion main surface, a first active-portion side surface in a width direction and orthogonal or substantially orthogonal to the first active-portion main surface and the second active-portion main surface and from which the first internal electrode layer and the second internal electrode layer are extended, a second active-portion side surface opposite from the first active-portion side surface and from which the first internal electrode layer and the second internal electrode layer are extended, a first active-portion end surface in a length direction and orthogonal or substantially orthogonal to the first active-portion main surface, the second active-portion main surface, the first active-portion side surface, and the second active-portion side surface and from which the first internal electrode layer is extended, and a second active-portion end surface opposite from the first active-portion end surface and from which the second internal electrode layer is extended, and inactive portions including a ceramic dielectric and covering the first active-portion main surface and the second active-portion main surface in the lamination direction, side margin portions covering the active portion and the inactive portions in the width direction, a first terminal electrode covering the first active-portion end surface and electrically connected to the first internal electrode layer, and a second terminal electrode covering the second active-portion end surface and electrically connected to the second internal electrode layer, in which the side margin portions define ridgeline portions, the side margin portions include a first segregate including silicon as a main ingredient and having a longest dimension of about 10 nm or greater and about 50 nm or smaller, and a plurality of second segregates each including silicon as a main ingredient and having a longest dimension of about 1 μm or greater.

Example embodiments of the present invention provide multilayer ceramic capacitors each with sufficient mechanical strength.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor of a first example embodiment of the present invention.

FIG. 2 is a sectional view taken along line 201-201 in

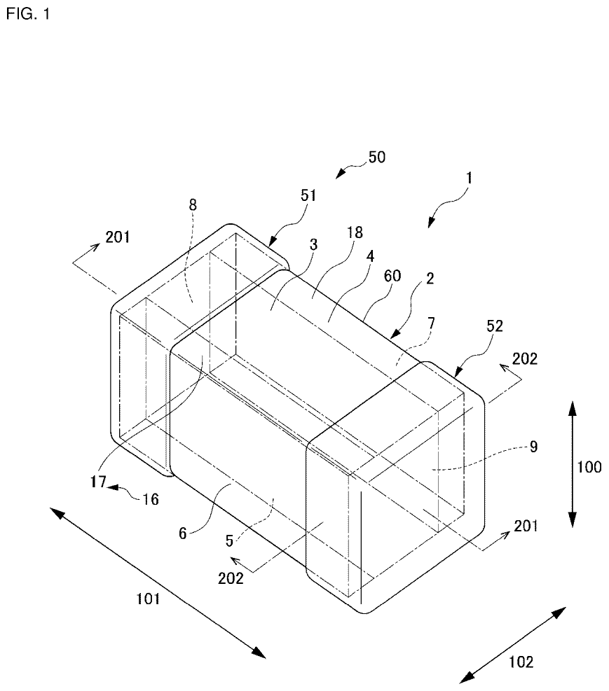

FIG. 1.

FIG. 3 is a sectional view taken along line 202-202 in FIG. 1.

FIG. 4 is a sectional view taken along a plane parallel or substantially parallel to a lamination direction of dielectric layers and a width direction.

FIG. 5 is a sectional view taken along a plane parallel or substantially parallel to a lamination direction of dielectric layers and a width direction.

FIG. 6 is a sectional view taken along a plane parallel or substantially parallel to a lamination direction of dielectric layers and a width direction.

FIG. 7 is a sectional view taken along a plane parallel or substantially parallel to a lamination direction of dielectric layers and a width direction.

FIG. 8 is a sectional view taken along a plane parallel or substantially parallel to a lamination direction of dielectric layers and a width direction.

FIG. 9 is a sectional view of the multilayer ceramic capacitor in FIG. 1 viewed at a second position.

FIG. 10 is a diagram showing a close-up of a frame 330 in FIG. 9.

FIG. 11 is a diagram showing a close-up of the frame 330 in FIG. 9.

FIG. 12 is a diagram illustrating a mechanical strength evaluation method.

FIG. 13 is a diagram showing results of a mechanical strength evaluation.

FIG. 14 is a diagram showing an overview of an annealing conditions.

FIG. 15 is a perspective view of a multilayer ceramic capacitor according to a second example embodiment of the present invention.

FIG. 16 is a sectional view taken along line 204-204 in

FIG. 14.

FIG. 17 is a sectional view taken along line 205-205 in FIG. 14.

FIG. 18 is a sectional view of the multilayer ceramic capacitor in FIG. 14 viewed at a second position.

FIG. 19 is a diagram showing a close-up of a frame 350 in FIG. 9.

FIG. 20 is a diagram showing a close-up of the frame 350 in FIG. 9.

### DETAILED DESCRIPTION OF THE EXAMPLE EMBODIMENTS

Example embodiments of the present invention will be described in detail below with reference to the drawings.

### First Example Embodiment

An overview of a multilayer ceramic capacitor 1 according to a first example embodiment of the present invention is described with reference to FIG. 1.

### Multilayer Ceramic Capacitor

FIG. 1 is a perspective view of the multilayer ceramic capacitor 1 of the first example embodiment. The multilayer ceramic capacitor 1 includes a ceramic base body 2 and terminal electrodes 50. The terminal electrodes 50 include a first terminal electrode 51 and a second terminal electrode 52.

### Ceramic Base Body

The ceramic base body 2 includes a multilayer body 3 and side margin portions 16. The side margin portions 16 include a first side margin portion 17 and a second side margin portion 18. The multilayer body 3 includes internal electrode layers 30 and dielectric layers 40.

### Directions for the Ceramic Base Body

The ceramic base body 2 has a rectangular or substantially rectangular solid shape. A direction in which the internal electrode layers 30 and the dielectric layers 40 are laminated is referred to as a lamination direction 100. One of the directions orthogonal or substantially orthogonal to the lamination direction 100 is referred to as a length direction 101. A direction orthogonal or substantially orthogonal to the lamination direction 100 and the length direction 101 is referred to as a width direction 102.

### Surfaces of the Ceramic Base Body

Two surfaces facing each other in the lamination direction 100 are referred to as a first base-body main surface 4 and a second base-body main surface 5. Two surfaces facing each other in the width direction 102 are referred to as a first base-body side surface 6 and a second base-body side surface 7. Two surfaces facing each other in the length direction 101 are referred to as a first base-body end surface 8 and a second base-body end surface 9.

### Ridgeline Portions and Corner Portions

A portion where each of two of the first base-body main surface 4, the second base-body main surface 5, the first base-body side surface 6, and the second base-body side surface 7 intersect is referred to as a ridgeline portion 60.

### Multilayer Body

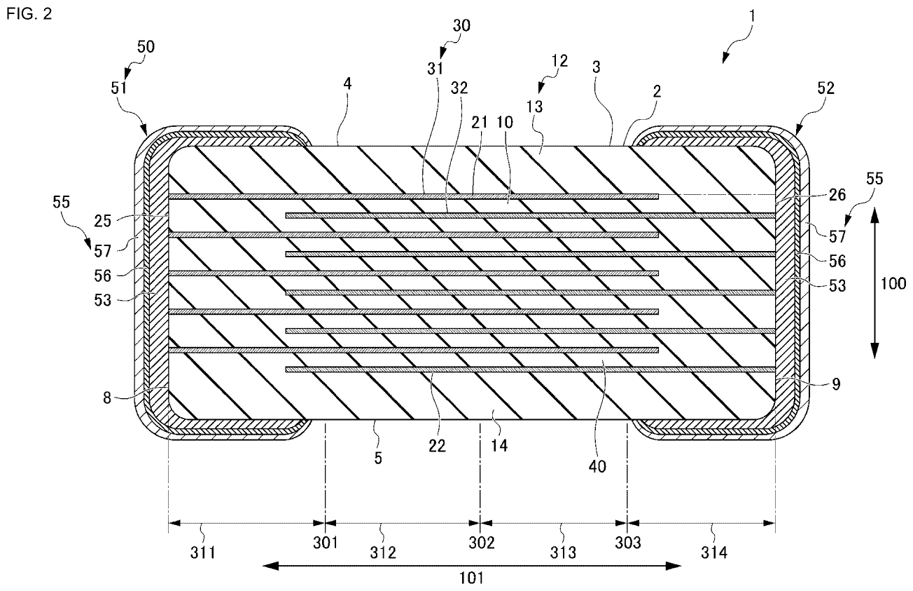

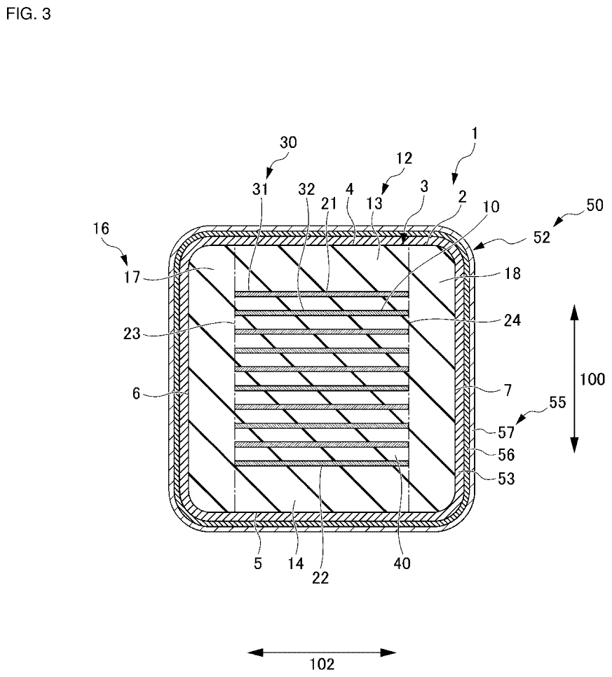

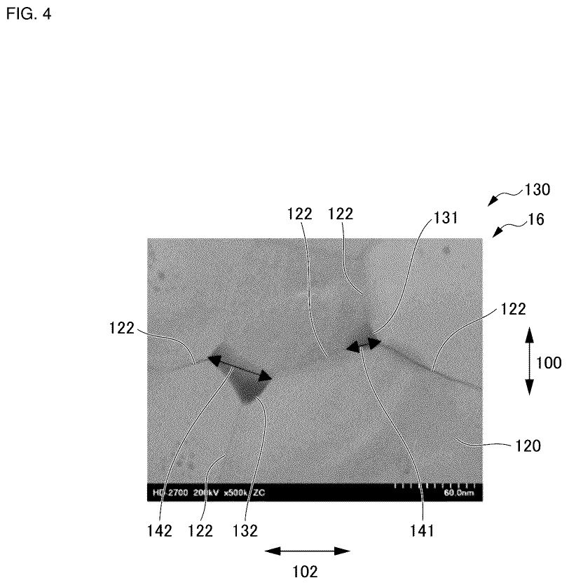

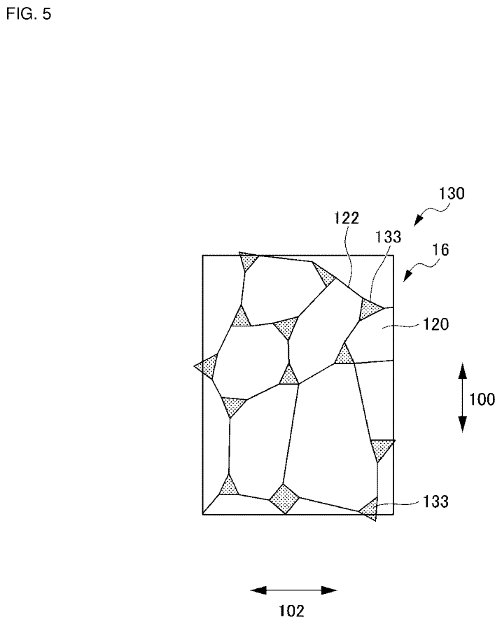

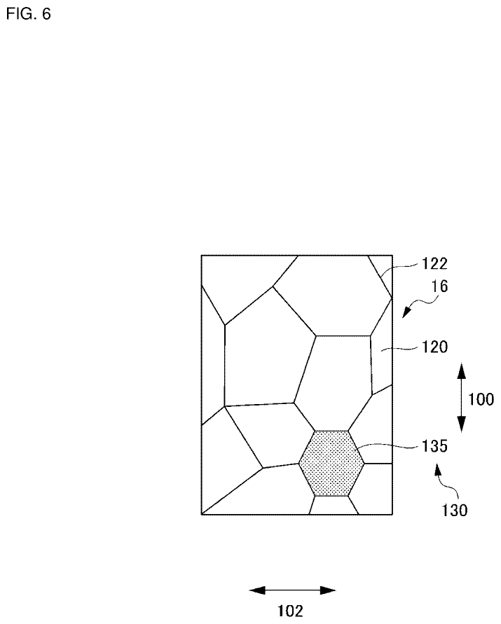

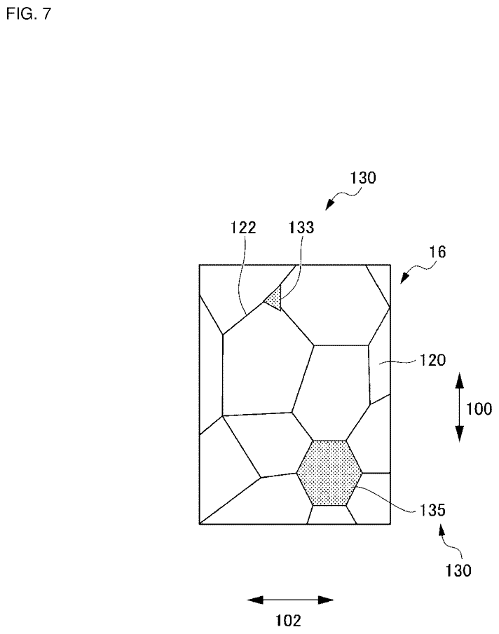

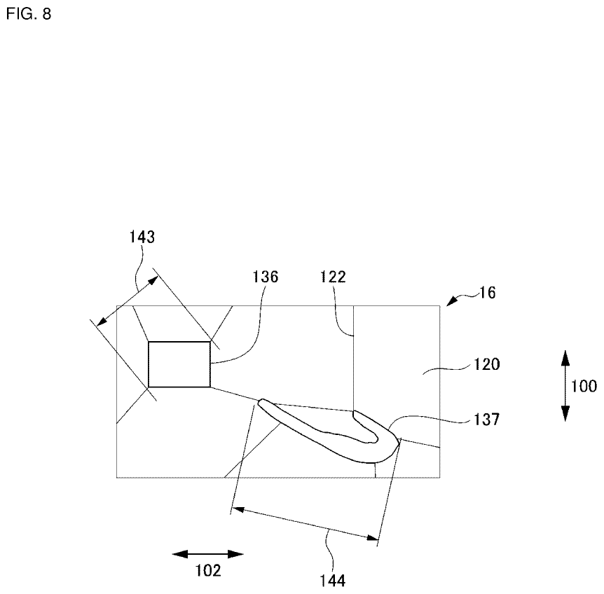

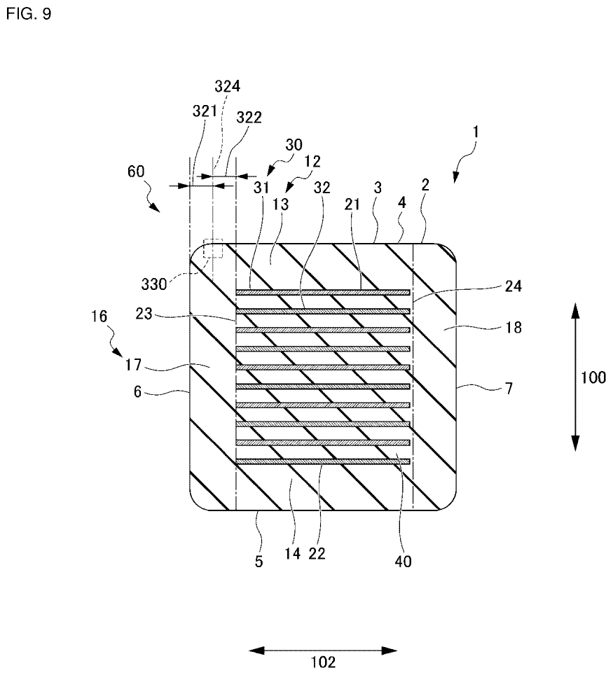

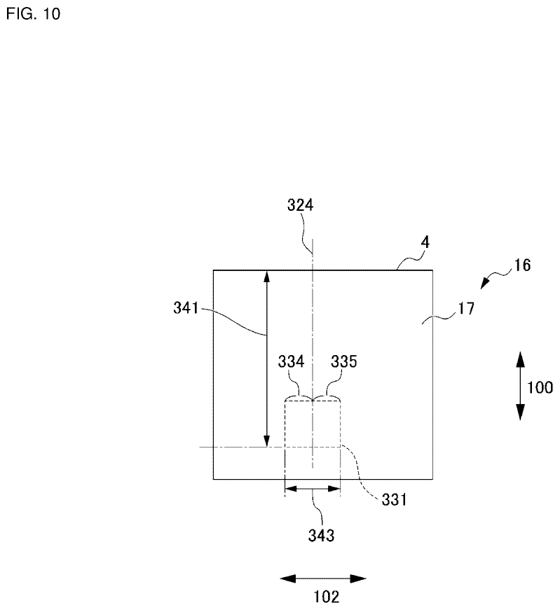

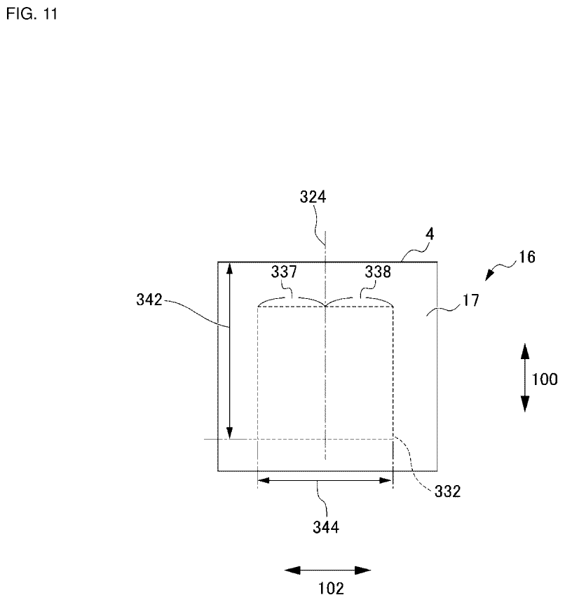

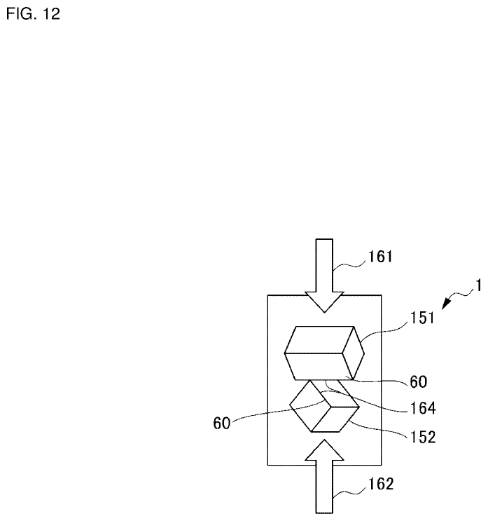

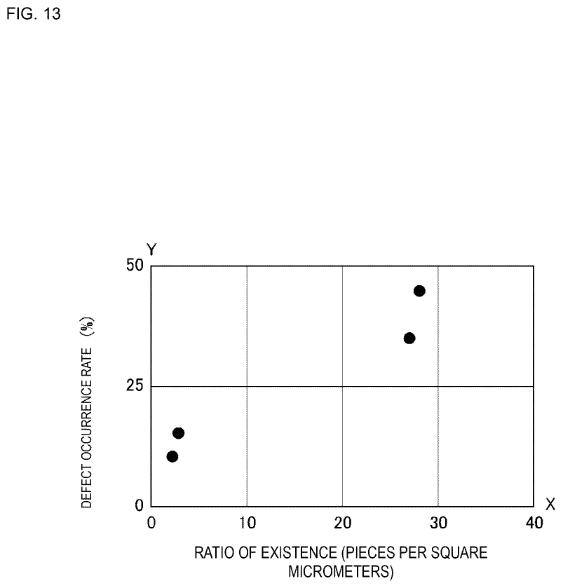

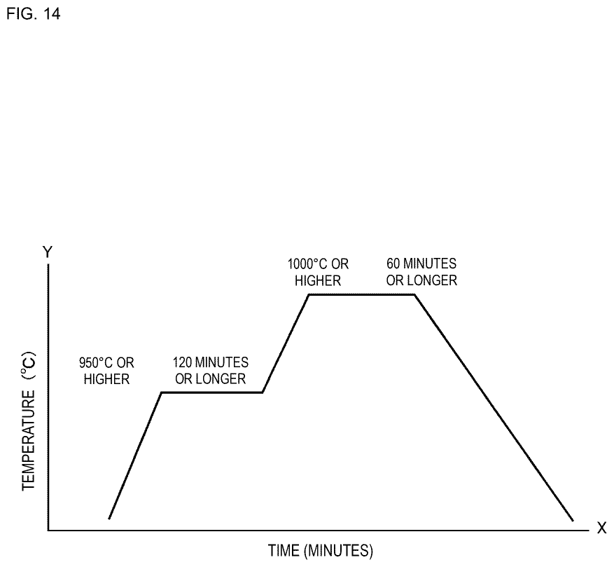

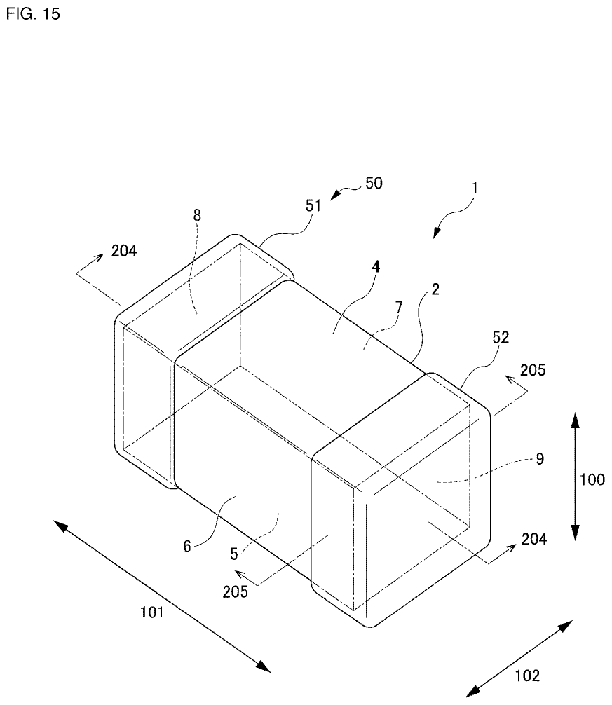

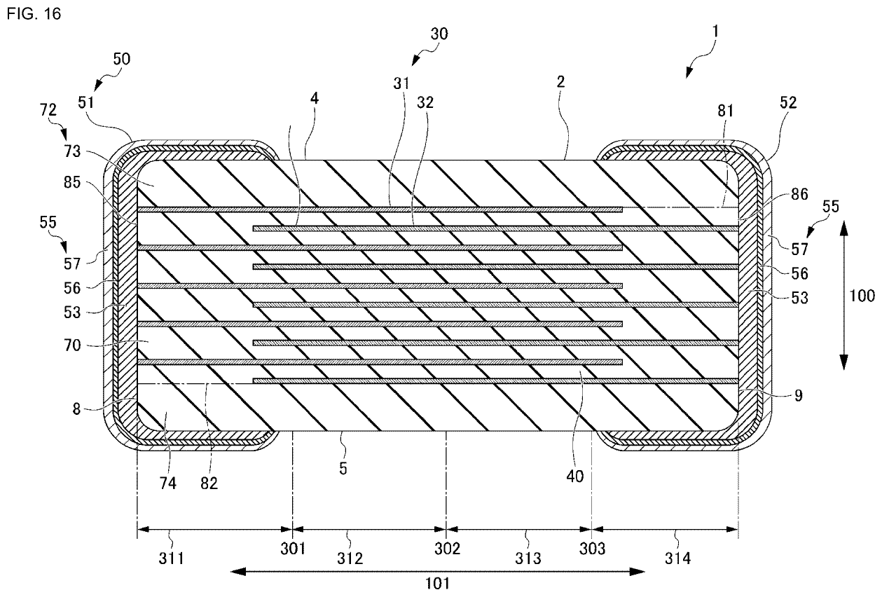

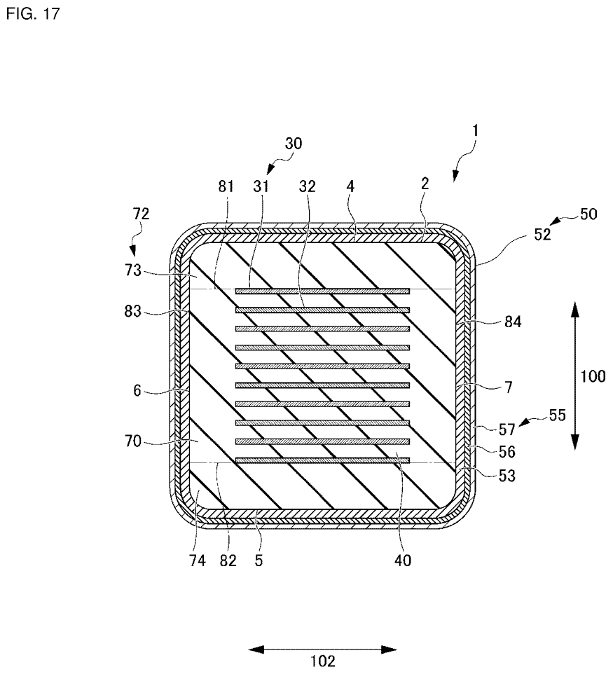

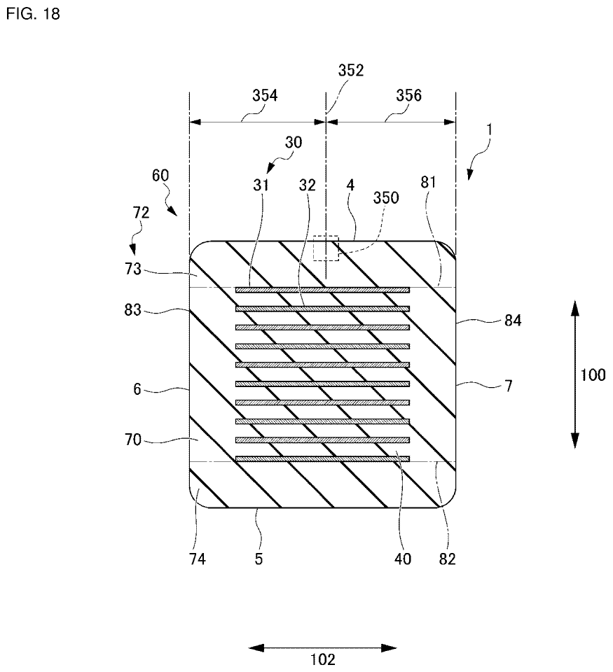

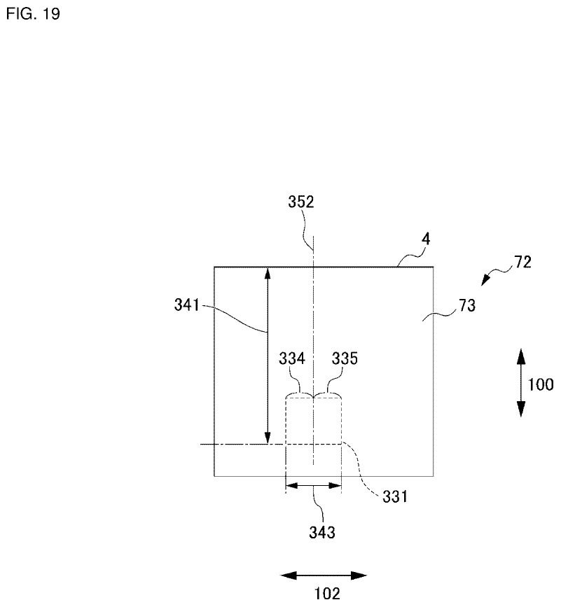

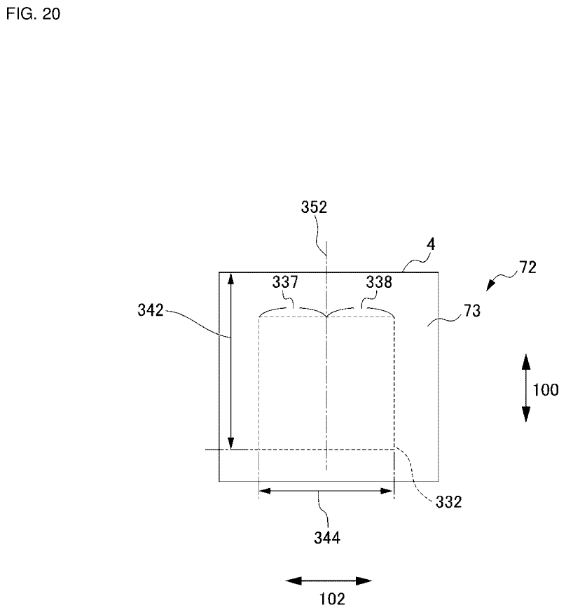

The structure of the multilayer body 3 is described with reference to FIG. 2. FIG. 2 is a sectional view taken along line 201-201 in FIG. 1. The multilayer body 3 includes a plurality of internal electrode layers 30 and a plurality of dielectric layers 40 that are laminated.

### Internal Electrode Layers

The internal electrode layers 30 include first internal electrode layers 31 and second internal electrode layers 32. The first internal electrode layers 31 are internal electrode layers 30 extended to the first base-body end surface 8. The second internal electrode layers 32 are internal electrode layers 30 extended to the second base-body end surface 9.

### Active Portion, Inactive Portions

The multilayer body 3 includes an active portion 10 and inactive portions 12. The active portion 10 and the inactive portions 12 are portions of the multilayer body 3 sectioned in the lamination direction 100.

The active portion 10 is a portion where the internal electrode layers 30 and the dielectric layers 40 are laminated. The inactive portions 12 sandwich the active portion 10 in the lamination direction 100. In the active portion 10, a portion where the first internal electrode layer 31 and the second internal electrode layer face each other is a portion at which a capacitance is generated. In contrast, the inactive portions 12 are portions at which a capacitance is not generated.

### Inactive Portions

The inactive portions 12 include a first inactive portion 13 and a second inactive portion 14. The first inactive portion 13 is a portion between the active portion 10 and the first base-body main surface 4. The second inactive portion 14 is a portion between the active portion 10 and the second base-body main surface 5. With the first inactive portion 13 and the second inactive portion 14, the inactive portions 12 sandwich the active portion 10 in the lamination direction 100. The inactive portions 12 may include dielectric sheets made of the same material as the dielectric layers 40 or a different material from the dielectric layers 40.

### Surfaces of the Active Portion

One of the surfaces of the active portion 10 perpendicular or substantially perpendicular to the lamination direction 100 is referred to as a first active-portion main surface 21. The surface of the active portion 10 which faces the first active-portion main surface 21 is referred to as a second active-portion main surface 22.

One of the surfaces of the active portion 10 perpendicular or substantially perpendicular to the width direction 102 is referred to as a first active-portion side surface 23. The surface of the active portion 10 which faces the first active-portion side surface 23 is referred to as a second active-portion side surface 24. The first active-portion side surface 23 and the second active-portion side surface 24 are not shown in FIG. 2. The first active-portion side surface 23 and the second active-portion side surface 24 are shown in FIG. 3 and the like. The internal electrode layers 30 are extended from the first active-portion side surface 23 and the second active-portion side surface 24.

One of the surfaces of the active portion 10 perpendicular or substantially perpendicular to the length direction 101 is referred to as a first active-portion end surface 25. The surface of the active portion 10 which faces the first active-portion end surface 25 is referred to as a second active-portion end surface 26. The first internal electrode layers 31 are extended from the first active-portion end surface 25. The second internal electrode layers 32 are extended from the second active-portion end surface 26.

The active portion 10 is surrounded by the first active-portion main surface 21, the second active-portion main surface 22, the first active-portion side surface 23, the second active-portion side surface 24, the first active-portion end surface 25, and the second active-portion end surface 26.

The first inactive portion 13 is a portion between the first active-portion main surface 21 and the first base-body main surface 4. The second inactive portion 14 is a portion between the second active-portion main surface 22 and the second base-body main surface 5.

### Material for the Internal Electrode Layers, Etc.

Examples of a material for the internal electrode layers 30 include metals such as nickel, copper, silver, palladium, or gold or alloys including at least one of the metals, such as an alloy of silver and palladium. There is no particular limitation as to an ingredient for the internal electrode layers 30 as long as it is a conductive material.

A preferable thickness of the internal electrode layers 30 is, for example, about 0.2 μm or greater and about 2.0 μm or smaller.

A preferable total number of the internal electrode layers 30 adding the number of first internal electrode layers 31 and the number of second internal electrode layers 32 together is, for example, 15 or greater and 2000 or smaller.

### Material for the Dielectric Layers, Etc.

A description is provided of a ceramic dielectric of the dielectric layers 40. Examples of the main ingredient of the ceramic dielectric include barium titanate, calcium titanate, strontium titanate, calcium zirconate, or strontium zirconate. The ceramic dielectric may include an accessory ingredient. Examples of the accessory ingredient include rare-earth oxides, silicon compounds, aluminum compounds, magnesium compounds, manganese compounds, iron compounds, chromium compounds, cobalt compounds, vanadium compounds, or nickel compounds. The ceramic dielectric is a perovskite oxide, for example. In the arrangement of atoms in the perovskite structure, an element preferably included the most in the B-site is titanium, for example.

A preferable thickness of a single dielectric layer 40 is, for example, about 0.3 μm or greater and about 10 μm or smaller. A preferable total number of dielectric layers 40 is, for example, 15 or greater and 2000 or smaller.

### Ceramic Base Body

With reference to FIG. 3, the structure of the ceramic base body 2 in the width direction 102 is described. FIG. 3 is a sectional view taken along line 202-202 in FIG. 1. As described earlier, the ceramic base body 2 includes the multilayer body 3 and the side margin portions 16. The side margin portions 16 include the first side margin portion 17 and the second side margin portion 18.

### Side Margin Portions

As shown in FIG. 3, the side margin portions 16 are disposed at the multilayer body 3. The side margin portions 16 are portions covering the active portion 10 and the inactive portions 12 in the width direction 102. In other words, the side margin portions 16 are portions covering the multilayer body 3 in the width direction 102. The ceramic base body 2 is configured by providing the side margin portions 16 at the multilayer body 3. The side margin portions 16 may include dielectric sheets made of the same material as the dielectric layers 40 or a different material from the dielectric layers 40.

The side margin portions 16 include the first side margin portion 17 and the second side margin portion 18. The first side margin portion 17 is the side margin portion 16 partially in contact with the first active-portion side surface 23. The first side margin portion 17 defines the first base-body side surface 6.

The second side margin portion 18 is the side margin portions 16 partially in contact with the second active-portion side surface 24. The second side margin portion 18 defines the second base-body side surface 7. The side margin portions 16 define the ridgeline portions 60.

### Size of the Ceramic Base Body

The size of the ceramic base body 2 is not limited to a particular size. A preferable length of the ceramic base body 2 in the length direction 101 is, for example, about 0.2 mm or greater and about 10 mm or smaller. A preferable length of the ceramic base body 2 in the width direction 102 is, for example, about 0.1 mm or greater and about 5 mm or smaller. A preferable length of the ceramic base body 2 in the lamination direction 100 is, for example, about 0.1 mm or greater and about 5 mm or smaller.

### Terminal Electrodes

The terminal electrodes 50 are described. As shown in FIG. 1, the terminal electrodes 50 include the first terminal electrode 51 and the second terminal electrode 52. The first terminal electrode 51 is the terminal electrode 50 connected to the first internal electrode layers 31. The second terminal electrode 52 is the terminal electrode 50 connected to the second internal electrode layers 32.

The first terminal electrode 51 is disposed at the first base-body end surface 8, a portion of the first base-body main surface 4, a portion of the second base-body main surface 5, a portion of the first base-body side surface 6, and a portion of the second base-body side surface 7. The second terminal electrode 52 is disposed at the second base-body end surface 9, a portion of the first base-body main surface 4, a portion of the second base-body main surface 5, a portion of the first base-body side surface 6, and a portion of the second base-body side surface 7.

Each terminal electrode 50 includes a foundation electrode layer 53, a nickel-plated layer 56, and a tin-plated layer 57, for example. They are disposed in the order of the foundation electrode layer 53, the nickel-plated layer 56, and the tin-plated layer 57, from the end surface of the ceramic base body 2.

The foundation electrode layer 53 is disposed on the end surface of the ceramic base body 2 and covers the end surface. The foundation electrode layer 53 extends from the end surface to a portion of the main surfaces and a portion of the side surfaces.

The foundation electrode layer 53 includes metal and glass. For example, the metal includes at least one of copper, nickel, silver, palladium, a silver-palladium alloy, or gold, or the like. The glass includes, for example, boron or silicon. The foundation electrode layer 53 is formed by applying a conductive paste to the ceramic base body 2 and performing firing. This conductive paste includes metal and glass. A preferable thickness of the foundation electrode layer 53 is, for example, about 3 μm or greater and about 100 μm or smaller.

The nickel-plated layer 56 covers the foundation electrode layer 53. The tin-plated layer 57 covers the nickel-plated layer 56.

Solder is used to mount the multilayer ceramic capacitor 1 onto a substrate or the like. The nickel-plated layer 56 helps prevent the solder from eroding the foundation electrode layer 53.

The tin-plated layer 57 improves the wettability of the solder with respect to the multilayer ceramic capacitor 1. This as a result facilitates mounting of the multilayer ceramic capacitor 1 onto a substrate or the like.

### Size of the Multilayer Ceramic Capacitor

The size of the multilayer ceramic capacitor 1 is not limited to a particular size. A preferable length of the multilayer ceramic capacitor 1 in the length direction 101 including the ceramic base body 2 and the terminal electrode 50 is, for example, about 0.2 mm or greater and about 10 mm or smaller. A preferable length of the multilayer ceramic capacitor 1 in the lamination direction 100 including the ceramic base body 2 and the terminal electrode 50 is, for example, about 0.1 mm or greater and about 5 mm or smaller. A preferable length of the multilayer ceramic capacitor 1 in the width direction 102 including the ceramic base body 2 and the terminal electrode 50 is, for example, about 0.1 mm or greater and about 10 mm or smaller.

### Segregates in the Side Margin Portions

Segregates 130 in the side margin portions 16 are described. A portion where silicon is segregated into a predetermined size is referred to as a segregate 130. Segregation of silicon occurs due to segregation of an oxide of silicon, e.g., a silicon dioxide.

The segregate 130 includes silicon as its main ingredient, but also may include other additives such as magnesium or aluminum, for example, in the process of firing. The main ingredient herein refers to an ingredient included by about 50% or more by weight, for example.

A segregate is an element included in the main ingredient of a ceramic or an added element that has solidified within the ceramic in the process of sintering and may be in an amorphous state or have crystallinity. The segregate also includes silicon, magnesium, aluminum, or the like, for example.

Based on FIG. 4, a description of a segregate is provided. FIG. 4 is a sectional view of the side margin portion 16 with respect to a cross section parallel or substantially parallel to the width direction 102 and the lamination direction 100. FIG. 4 is a cross section of the side margin portion 16 taken along a plane parallel or substantially parallel to the lamination direction 100 and the width direction 102.

The cross section can be observed using, for example, an SEM (scanning electron microscope) or a TEM (transmission electron microscope)/a STEM (scanning transmission electron microscope).

As shown in FIG. 4, the side margin portion 16 includes dielectric grains 120 and grain boundaries 122. The grain boundaries 122 are the outer peripheral edge of the dielectric grain 120. The segregate 130 mainly exists at a portion where three or more grain boundaries 122 try to intersect. FIG. 4 exemplifies two segregates 130. The two segregates 130 include a segregate 131 and a segregate 132.

The segregate 131 and the segregate 132 both exist at a portion where three grain boundaries 122 try to intersect. The shape of the segregate 131 in sectional view is triangular or substantially triangular. The shape of the segregate 132 in sectional view is quadrilateral or substantially quadrilateral. The segregate 130 may be in various shapes, as shown with the segregate 131 and the segregate 132.

A double-sided arrow 141 shown in FIG. 4 indicates the longest dimension 141 of the segregate 131. A double-sided arrow 142 shown in FIG. 4 indicates the longest dimension 142 of the segregate 132. A description of the longest dimension will be provided later with reference to FIG. 8.

The shape, size, and the like of the segregate 130 are not limited to the example shown in FIG. 4. FIGS. 5, 6, and 7 are each a sectional view of the side margin portion 16 taken along a plane parallel or substantially parallel to the lamination direction 100 and the width direction 102.

A segregate 133 shown in FIG. 5 exists at most of the portions where the grain boundaries 122 try to intersect. The segregate 133 exists mainly at a portion where three grain boundaries 122 try to intersect.

A segregate 135 shown in FIG. 6 is at some of the portions where the grain boundaries 122 try to intersect. The segregate 135 is at a portion where four or more grain boundaries 122 try to intersect. The segregate 135 is larger in size than the segregate 133 shown in FIG. 5. The segregate 135 is at a lower density than the segregate 133 shown in FIG. 5.

### First Segregates and Second Segregates

The segregate 130 is classified based on its longest dimension. The segregate 130 measuring, for example, about 10 nm or greater and about 50 nm or smaller in its longest dimension is referred to as a first segregate 133. The segregate 130 measuring, for example, about 1 μm or greater in its longest dimension is referred to as a second segregate 135. FIG. 5 shows an example of how the first segregate 133 is provided. FIG. 6 shows an example of how the second segregate 135 is provided.

The first segregate 133 and the second segregate 135 may coexist. FIG. 7 shows an example of how the first segregate 133 and the second segregate 135 coexist.

### Longest Dimension

With reference to FIG. 8, descriptions are provided of the longest dimension and how to measure the longest dimension. FIG. 8 is a sectional view of the side margin portion 16 taken along a plane parallel or substantially parallel to the lamination direction 100 and the width direction 102. A longest dimension is the distance between two points on the periphery of the segregate 130 in sectional view, the two points being the farthest away from each other. A length 143 in FIG. 8 indicates the longest dimension 143 of a segregate 136. A length 144 in FIG. 8 indicates the longest dimension 144 of a segregate 137.

The shape of the segregate 136 shown in FIG. 8 in sectional view is rectangular. The shape of the segregate 137 in sectional view is roughly in the shape of the letter J. The shape of the segregate 130 may be in various shapes, as shown with the segregate 136 and the segregate 137.

Whatever shape the segregate 130 is in, its longest dimension can be determined by finding two points on the periphery of the segregate 130 which are farthest away from each other.

A segregate existing at the interface between the dielectric grains 120 and a portion extending from the segregate 130 along the grain boundary are not included for the measurement of the longest dimension of the segregate 130. An example of the dielectric grain 120 is a barium titanate grain.

### Evaluation Positions

The positions and regions to evaluate the segregate 130 are described. Evaluation of the segregate 130 includes measuring the longest dimension of the segregate 130, the number of segregates 130 in existence, and calculating the probability of existence of the segregate 130.

FIG. 2 shows a first position 301, a second position 302, and a third position 303. The first position 301, the second position 302, and the third position 303 are the positions of borders dividing the ceramic base body 2 into four equal or substantially equal portions in the length direction 101. A length 311, a length 312, a length 313, and a length 314 are equal or substantially equal in length.

FIG. 9 is a diagram showing a cross section of the multilayer ceramic capacitor 1 taken at the second position 302 along a plane parallel or substantially parallel to the lamination direction 100 and the width direction 102. Cross sections of the multilayer ceramic capacitor 1 taken at the first position 301 and the third position 303 are the same as or similar to those in FIG. 9.

The segregate 130 is evaluated at three locations: the first position 301, the second position 302, and the third position 303. The average of evaluation results on the three locations, namely the first position 301, the second position 302, and the third position 303, is used as an evaluation result on the multilayer ceramic capacitor 1. Also, for example, at the second position 302, it is possible to determine whether the cross section includes the first segregate 133 including silicon as the main ingredient and measuring about 10 nm or greater and about 50 nm or smaller in its longest dimension and the second segregate 135 including silicon as the main ingredient and measuring about 1 μm or greater in its longest dimension and whether a plurality of second segregates 135 exist on the cross section. The following describes the second position 302 as an example.

FIG. 9 shows a fourth position 324. The fourth position 324 is the position of a border dividing the side margin portions 16 into two equal or substantially equal portions in the width direction 102. A length 321 and a length 322 are equal or substantially equal in length.

### Evaluation Regions

FIGS. 10 and 11 are diagrams of a close-up of a frame 330 in FIG. 9. A frame 331 in FIG. 10 indicates a first evaluation region 331. A frame 332 in FIG. 11 indicates a second evaluation region 332. The first evaluation region 331 and the second evaluation region 332 are a field of view evaluated for segregates of silicon dioxide or the like, for example. The first evaluation region 331 and the second evaluation region 332 have a square or substantially square shape.

The probability of existence of the first segregate 133 is calculated based on a result of observation of the first evaluation region 331. The number of first segregates 133 and second segregates 135 in existence is determined from a result of observation of the second evaluation region 332.

### First Evaluation Region

The first evaluation region 331 is described with reference to FIG. 10. In FIG. 10, the length of each side of the first evaluation region 331 is indicated as a length 343. The length 343 is, for example, about 2 μm. The first evaluation region 331 is in the size of, for example, about 2 μm×about 2 μm. The field of view of the first evaluation region 331 is, for example, about 4 μm².

The center position of the first evaluation region 331 in the width direction 102 is at the fourth position 324. A length 334 and a length 335 are equal or substantially equal.

The first evaluation region 331 is located within a region of, for example, about 5 μm from the first base-body main surface 4. The length 341 indicates the distance between the first base-body main surface 4 and, of the four sides defining the first evaluation region 331, one of the two sides parallel or substantially parallel to the width direction 102 which is farther away from the first base-body main surface 4. The length 341 is, for example, about 5 μm.

### Second Evaluation Region

The second evaluation region 332 is described with reference to FIG. 11. In FIG. 11, the length of each side of the second evaluation region 332 is indicated as a length 344. The length 344 is, for example, about 3 μm. The second evaluation region 332 is in the size of, for example, about 3 μm×about 3 μm. The field of view of the second evaluation region 332 is, for example, about 9 μm².

The center position of the second evaluation region 332 in the width direction 102 is at the fourth position 324. A length 337 and a length 338 are equal or substantially equal.

The second evaluation region 332 is located within a region of, for example, about 5 μm from the first base-body main surface 4. The length 342 indicates the distance between the first base-body main surface 4 and, of the four sides defining the second evaluation region 332, one of the two sides parallel or substantially parallel to the width direction 102 which is farther away from the first base-body main surface 4. The length 342 is, for example, about 5 μm.

The first evaluation region 331 and the second evaluation region 332 are both within the surface layer region 400.

The first evaluation region 331 is an evaluation region used to evaluate the first segregate. The second evaluation region 332 is an evaluation region used to evaluate the second segregate. The first evaluation region 331 is mainly used to evaluate of the first segregate 133. The second evaluation region 332 is used to evaluate the second segregate 135.

As thus described, evaluation of the segregates 130 is conducted near the ridgeline portion 60 of the ceramic base body 2, at three locations dividing the ceramic base body 2 into four equal or substantially equal portions in the length direction 101.

Main criteria of the evaluation are, as described earlier, the number of first segregates 133 included in the first evaluation region 331 and the number of first segregates 133 and second segregates 135 included in the second evaluation region 332.

For each of the evaluation criteria, the longest dimensions of the segregates 130 are measured. Each segregate 130 is classified based on its longest dimension into the first segregate 133, the second segregate 135, or the segregate 130 applicable to neither of them.

The segregates 130 tend to distribute ununiformly near the main surface of the ceramic base body 2. This is because segregates are released to the outside of the ceramic base body 2 more easily from the main surface of the ceramic base body 2. For this reason, the evaluation regions are set at a predetermined distance from the main surface of the ceramic base body 2. This reduces variances in evaluation results about the segregates 130.

In the multilayer ceramic capacitor 1 of the present example embodiment, a first segregate and a second segregate exist in the second evaluation region 332, with a plurality of second segregates are provided.

Also, in the multilayer ceramic capacitor 1 of the present example embodiment, for example, 32 or fewer first segregates exist in the first evaluation region 331. In other words, the ratio of existence of the first segregate in the first evaluation region 331 is, for example, eight or fewer pieces per 1 μm².

Thus, the multilayer ceramic capacitor 1 having sufficient mechanical strength can be provided.

In a case where the first segregates 133 exist at a high existence ratio as shown in FIG. 5, the strength of the side margin portions 16 tends to lower, because chipping or cracking may occur originating from the first segregates 133.

A portion where the segregate 130 exists is a portion where mechanical characteristics (such as Young's modulus and Poisson's ratio) differ in the dielectric. A portion where mechanical characteristics differ is a location where stress concentrates. A portion where the segregate 130 exists is a defect from the viewpoint of fracture mechanics. A defect increases stress concentration when being adjacent to another defect. Thus, when portions with the segregates 130 exist at a high density with grain boundaries interposed therebetween, such a state can be said to be vulnerable to external forces. Thus, chipping and the like can easily occur originating from the first segregates 133.

In contrast, as shown in FIGS. 6 and 7, when segregates accumulate, decreasing the segregates 130 with short longest dimensions and aggregating them into a segregate 130 with a long longest dimension, the number of segregates 130 decreases, which reduces or prevents a decrease in the strength of the side margin portions 16. Thus, when a plurality of first segregates 133 accumulate to define the second segregate 135, a decrease in the strength of the side margin portions 16 can be reduced or prevented. This effect is notable in the surface layer region. The surface layer region is a region extending, for example, about 5 μm from the surface of the ceramic base body 2 into the ceramic base body 2.

The number of first segregates 133 does not need to be zero in order to reduce or prevent a decrease in the strength of the side margin portions 16. For example, as shown in FIG. 7, there may be a first segregate 133 remaining. In this case, it is preferable that the first segregate 133 and the second segregate 135 are not adjacent to each other, as shown in FIG. 7.

The length of the side margin portion 16 in the width direction 102 is, for example, preferably about 50 μm or smaller. The length of the side margin portion 16 in the width direction 102 is, for example, more preferably about 40 μm or smaller.

The length of the inactive portion 12 in the lamination direction 100 is, for example, preferably about 60 μm or smaller and more preferably about 35 μm or smaller.

The thickness of the dielectric layer 40 is, for example, preferably about 0.6 μm or smaller.

In the multilayer ceramic capacitor 1 of the present example embodiment, the multilayer ceramic capacitor 1 can have mechanical strength even if the multilayer ceramic capacitor 1 is thin and the length, in the width direction 102, of the side margin portion 16 forming the ridgeline portion 60 is short, i.e., the thickness of the side margin portion 16 is thin.

The longest dimension of the second segregate 135 is preferably double or more the grain size of the dielectric grain 120. The longest dimension of the first segregate 133 is preferably about half or less the grain size of the dielectric grain 120. This allows the multilayer ceramic capacitor 1 to have even higher mechanical strength. Also, even if the length of the inactive portion 12 in the lamination direction 100, i.e., the thickness of the inactive portion 12, is, for example, about 35 μm or smaller, the multilayer ceramic capacitor 1 can have sufficient mechanical strength. Also, even if the length, in the width direction 102, of the side margin portion 16 forming the ridgeline portion 60, i.e., the thickness of the side margin portion 16, is, for example, about 40 μm or smaller, the multilayer ceramic capacitor 1 can have sufficient mechanical strength.

### Mechanical Strength Evaluation Method

An example of a mechanical strength evaluation method is described with reference to FIG. 12. FIG. 12 is a diagram showing how two multilayer ceramic capacitors 1 collide against each other. The mechanical strengths of the multilayer ceramic capacitors 1 are evaluated by collision of multilayer ceramic capacitors 1 against each other. The multilayer ceramic capacitor 1 after collision is observed using a microscope. As a result of observation, the multilayer ceramic capacitor 1 on which a structural defect is confirmed is evaluated as defective.

Specifically, a first one of the two multilayer ceramic capacitors 1, namely a multilayer ceramic capacitor 151, is tilted by, for example, about 45° relative to a multilayer ceramic capacitor 152. An angle 164 indicates the angle between the ridgeline portion 60 of the first multilayer ceramic capacitor 151 and the ridgeline portion 60 of the second multilayer ceramic capacitor 152. The angle 164 is, for example, about 45°.

The multilayer ceramic capacitor 151 tilted by, for example, about 45° is moved in the direction of an arrow 161, and the multilayer ceramic capacitor 152 is moved in the direction of an arrow 162. Then, the ridgeline portion 60 of the multilayer ceramic capacitor 151 extending in the length direction of the multilayer ceramic capacitor 151 and the ridgeline portion 60 of the multilayer ceramic capacitor 152 extending in the length direction of the multilayer ceramic capacitor 152 are collided against each other. The speed of collision is, for example, about 2.4 m/s. Twenty pairs of multilayer ceramic capacitors 1 are collided against each other and are observed for the presence of a structural defect.

### Mechanical Strength Evaluation Results

Mechanical strength evaluation results are described based on FIG. 13. FIG. 13 is a graph showing the relationship between a ratio of existence of the first segregate 133 and a defect occurrence rate in the mechanical strength evaluation. The X-axis of the graph in FIG. 13 represents the ratio of existence of the first segregate 133. The Y-axis of the graph in FIG. 13 represents the defect occurrence rate. The defect occurrence rate represents the percentage of defects among 20 test pairs.

As shown in FIG. 13, when the ratio of existence of the first segregate 133 in the first evaluation region 331 is, for example, 20 or more pieces/μm², the defect occurrence rate is, for example, about 30% or higher. Meanwhile, when the ratio of existence of the first segregate 133 is, for example, ten or fewer pieces/μm², the defect occurrence rate is, for example, about 20% or lower. In this way, the defect occurrence rate can be reduced when the ratio of existence of the first segregate 133 is ten or fewer pieces/μm² or preferably eight or fewer pieces/μm², for example.

Similarly, when the second evaluation region 332 includes the first segregate 133 and a plurality of the second segregate 135, the defect occurrence rate can be lower than when the second evaluation region 332 includes a large number of first segregates 133 and does not include the second segregate 135.

### Method for Fabricating the Multilayer Ceramic Capacitor of the First Example Embodiment

An example of a method for fabricating the multilayer ceramic capacitor 1 is described.
(1) A precursor of the multilayer body 3 is prepared. The precursor means pre-firing. The precursor of the multilayer body 3 is a precursor before dielectric sheets for the side margin portions 16 are provided.

Dielectric sheets for the multilayer body 3 and a conductive paste for the internal electrode layers 30 are prepared. The dielectric sheets and the conductive paste for the internal electrode layers 30 include a binder and a solvent. The binder and the solvent may be, for example, an organic binder and an organic solvent that are publicly known.
(2) The conductive paste for the internal electrode layers 30 is applied on the dielectric sheets for printing in a predetermined pattern. As a result, an internal electrode layer pattern is formed on each dielectric sheet. Examples of the printing method include screen printing and gravure printing.
(3) A predetermined number of dielectric sheets on which no internal electrode layer pattern is printed are laminated. These laminated layers are layers including the inactive portion 12 located on one side. On top of that, the dielectric sheets on which the internal electrode layer pattern is printed are sequentially laminated. These laminated layers are layers including the active portion 10. On top of that, a predetermined number of dielectric sheets on which no internal electrode layer pattern is printed are laminated. These laminated layers are layers including the inactive portion 12 located on the other side.
(4) The laminated sheets are pressed in the lamination direction to fabricate a multilayer block. Isostatic press is an example of the pressing method.
(5) The multilayer block is cut. In the cutting, the conductive paste corresponding to the internal electrode layers 30 is exposed at both sides in the width direction 102. At both sides of the cut block in the width direction 102, dielectric sheets for forming the side margin portions 16 are disposed. After that, sintering and cutting are performed, forming the ceramic base body 2. The following describes this sequentially.
(6) Dielectric sheets for the side margin portions 16 are fabricated. A dielectric material for the dielectric sheets may be the same as the dielectric material for the active portion 10 and the inactive portions 12. An additive may be added to dielectric powder formed from this dielectric material.
(7) The dielectric sheet for the side margin portion 16 is pressed against the precursor of the multilayer body 3 and then punched to be formed into a layer to define and functions as the side margin portion 16. Next, another dielectric sheet for the side margin portion 16 is pressed similarly against the other side of the precursor of the multilayer body 3 and then punched to be formed into a layer to define and function as the side margin portion on the other side. The punching may be performed after the dielectric sheets for the side margin portions are pressed against both sides of the precursor of the multilayer body 3.
(11) A multilayer chip including the layers to define and function as the side margin portions 16 formed thereon is subjected to a degreasing process in a nitrogen atmosphere under predetermined conditions. After that, in a mixed atmosphere of, for example, nitrogen, hydrogen, and steam, the multilayer chip is fired at a predetermined temperature, thus obtaining the sintered ceramic base body 2.

After the firing, the multilayer ceramic capacitor 1 of the present example embodiment is subjected to an annealing process at high temperature. This is described with reference to FIG. 14. FIG. 14 is a diagram showing an overview of annealing conditions. The X-axis of the graph shown in FIG. 14 represents time. The Y-axis of the graph shown in FIG. 14 represents temperature. is fired under the following

The multilayer chip conditions: a rate of temperature increase of about 100° C. or higher per minute and the maximum temperature of about 1200° C. or higher. After that, annealing is performed. In the multilayer chip after the above firing, densification has progressed, but it is thought that release of segregates does not progress sufficiently. This is why an annealing process is performed at high temperature.

In the annealing process, for example, about 950° C. or higher is maintained for about 120 minutes or longer. After that, about 1000° C. or higher is maintained for about 60 minutes or longer. The annealing process thus performed promotes release of segregates. The annealing process further promotes gathering of minute segregates 130 and formation of large segregates 130. Specifically, the first segregates 133 gather and formation of the second segregate 135 is promoted.

The sintered ceramic base body 2 is obtained by such firing and annealing process.
(12) The terminal electrode 50 is formed on each of the two end surfaces of the sintered ceramic base body 2, namely the first base-body end surface 8 and the second base-body end surface 9. The multilayer ceramic capacitor 1 is thus fabricated. The terminal electrodes 50 may be formed using a publicly known method. For example, a conductive paste including a conductive ingredient such as copper or nickel as its main ingredient is applied to the end surfaces of the base body portion where the internal electrode layers are extended and exposed and is baked, forming the foundation layer electrode layer 54. The foundation layer electrode layer 54 may be formed by, for example, the following method: applying a conductive paste to both end surfaces of a precursor of the pre-fired ceramic base body 2 and then performing a firing process. After the formation of the foundation electrode layer 53, the nickel-plated layer 56 and the tin-plated layer 57 are formed on the surface of the foundation electrode layer 53 through electrolytic plating. A multilayer ceramic capacitor is thus fabricated

### Second Example Embodiment

An overview of a multilayer ceramic capacitor 1 according to a second example embodiment of the present invention is described with reference to FIG. 15. The following mainly describes points different from the first example embodiment. Points not particularly stated are the same or substantially the same as those in the first example embodiment.

### Multilayer Ceramic Capacitor

FIG. 15 is a perspective view of the multilayer ceramic capacitor 1 of the second example embodiment. The ceramic base body 2 of the first example embodiment includes the multilayer body 3 and the side margin portions 16. The ceramic base body 2 of the second example embodiment includes an inner layer portion 70 and an outer layer portion 72. The inner layer portion 70 and the outer layer portion 72 are not shown in FIG. 15. The inner layer portion 70 and the outer layer portion 72 are shown in FIGS. 16 and 17. In the first example embodiment, the internal structure of the ceramic base body 2 is described using the terms an active portion and an inactive portion. In the second example embodiment, the internal structure of the ceramic base body 2 is described using the terms an inner layer portion and an outer layer portion. The active portion and the inner layer portion refer to regions different from each other, and the inactive portions and the outer layer portions refer to regions different from each other.

### Inner Layer Portion and Outer Layer Portions

With reference to FIGS. 16 and 17, the inner layer portion 70 and the outer layer portions 72 are described. FIG. 16 is a sectional view taken along line 204-204 in FIG. 15. FIG. 17 is a sectional view taken along line 205-205 in FIG. 150. As shown in FIGS. 16 and 17, the ceramic base body 2 includes the inner layer portion 70 and the outer layer portions 72. The inner layer portion 70 and the outer layer portions 72 are portions of the ceramic base body 2 sectioned in the lamination direction 100.

As shown in FIG. 17, the inner layer portion 70 and the outer layer portions 72 are each continuous from the first base-body side surface 6 to the second base-body side surface 7 in the width direction 102. In contrast, in the first example embodiment, the active portion 10 and the inactive portions 12 are not continuous from the first base-body side surface 6 to the second base-body side surface 7 in the width direction 102, as shown in FIG. 3. This is because, in the multilayer ceramic capacitor 1 of the first example embodiment, the first base-body side surface 6 and the second base-body side surface 7 are defined by the side margin portions 16.

The inner layer portion 70 is a portion where the internal electrode layers 30 and the dielectric layers 40 are laminated. The outer layer portions 72 may include dielectric sheets made of the same material as the dielectric layers 40 or a different material from the dielectric layers 40.

### Outer Layer Portions

The outer layer portions 72 include a first outer layer portion 73 and a second outer layer portion 74. The first outer layer portion 73 is a portion between the inner layer portion 70 and the first base-body main surface 4. The second outer layer portion 74 is a portion between the inner layer portion 70 and the second base-body main surface 5. With the first outer layer portion 73 and the second outer layer portion 74, the outer layer portions 72 sandwich the inner layer portion 70 in the lamination direction 100. Also, in the second example embodiment, the outer layer portions 72 define the ridgeline portions 60. The length of the outer layer portion 72 in the lamination direction 100 is, for example, preferably about 60 μm or smaller and more preferably about 35 μm or smaller.

### Surfaces of the Inner Layer Portion

One of the surfaces of the inner layer portion 70 which are perpendicular or substantially perpendicular to the lamination direction 100 is referred to as a first inner-layer-portion main surface 81. The surface of the inner layer portion 70 which faces the first inner-layer-portion main surface 81 is referred to as a second inner-layer-portion main surface 82.

One of the surfaces of the inner layer portion 70 which are perpendicular or substantially perpendicular to the width direction 102 is referred to as a first inner-layer-portion side surface 83. The surface of the inner layer portion 70 which faces the first inner-layer-portion side surface 83 is referred to as a second inner-layer-portion side surface 84. The first inner-layer-portion side surface 83 and the second inner-layer-portion side surface 84 are not shown in FIG. 16. The first inner-layer-portion side surface 83 and the second inner-layer-portion side surface 84 are shown in FIG. 17. The first inner-layer-portion side surface 83 defines a portion of the first base-body side surface 6. The second inner-layer-portion side surface 84 defines a portion of the second base-body side surface 7.

One of the surfaces of the inner layer portion 70 which are perpendicular or substantially perpendicular to the length direction 101 is referred to as a first inner-layer-portion end surface 85. The surface of the inner layer portion 70 which faces the first inner-layer-portion end surface 85 is referred to as a second inner-layer-portion end surface 86. The first internal electrode layers 31 are extended from the first inner-layer-portion end surface 85. The second internal electrode layers 32 are extended from the second inner-layer-portion end surface 86. The first inner-layer-portion end surface 85 defines a portion of the first base-body end surface 8. The second inner-layer-portion end surface 86 defines a portion of the second base-body end surface 9.

The inner layer portion 70 is surrounded by the first inner-layer-portion main surface 81, the second inner-layer-portion main surface 82, the first inner-layer-portion side surface 83, the second inner-layer-portion side surface 84, the first inner-layer-portion end surface 85, and the second inner-layer-portion end surface 86.

The first outer layer portion 73 is a portion between the first inner-layer-portion main surface 81 and the first base-body main surface 4. The second outer layer portion 74 is a portion between the second inner-layer-portion main surface 82 and the second base-body main surface 5.

The dielectric layers 40 are disposed in the inner layer portion 70. The ceramic dielectric of the dielectric layers 40 and the ceramic dielectric of the outer layer portion 72 may have the same composition or different compositions.

A preferable total number of dielectric layers 40 is, for example, 15 or greater and 2000 or smaller.

### Ceramic Base Body

As described earlier, the multilayer ceramic capacitor 1 of the second example embodiment does not include the side margin portions 16. The ceramic base body 2 of the multilayer ceramic capacitor 1 of the second example embodiment includes the inner layer portion 70 and the outer layer portions 72 described above.

### Terminal Electrodes

The terminal electrodes 50 are provided to the ceramic base body 2, thus defining the multilayer ceramic capacitor 1. The terminal electrodes 50 are as described in the first example embodiment.

### Segregates in the Outer Layer Portions

The segregates 130 in the outer layer portions 72 are described. Points different from the segregates 130 in the side margin portions 16 in the first example embodiment are mainly described. In the first example embodiment, the segregates 130 in the side margin portions 16 are evaluated. In the second example embodiment, the segregates 130 in the outer layer portion 72 are evaluated.

FIG. 18 is a diagram showing a cross section of the multilayer ceramic capacitor 1 at the second position 302 in FIG. 6 along a plane parallel or substantially parallel to the lamination direction 100 and the width direction 102. Cross sections of the multilayer ceramic capacitor 1 at the first position 301 and the third position 303 are the same as or similar to FIG. 18.

FIG. 18 shows a fifth position 352. The fifth position 352 is a position at the border dividing the outer layer portion 72 into two equal or substantially equal portions in the width direction 102. A length 354 and a length 356 are the same or substantially the same.

### Evaluation Regions

FIGS. 19 and 20 are each a diagram of a close-up of a frame 350 in FIG. 18. The frame 331 in FIG. 19 indicates the first evaluation region 331. The frame 332 in FIG. 20 indicates the second evaluation region 332.

As shown in FIG. 19, the center position of the first evaluation region 331 in the width direction 102 is at the fifth position 352. Also, as shown in FIG. 20, the center position of the second evaluation region 332 in the width direction 102 is at the fifth position 352.

In the first example embodiment, the center position of the first evaluation region 331 in the width direction 102 and the center position of the second evaluation region 332 in the width direction 102 are both at the fourth position 324. The positions of the evaluation regions in the width direction 102 are different between the first example embodiment and the second example embodiment.

In the multilayer ceramic capacitor 1 of the first example embodiment, the second evaluation region 332 in the outer layer portion 72 includes the first segregate 133 and a plurality of the second segregate 135. Also, the ratio of existence of the first segregate 133 in the first evaluation region 331 in the outer layer portion 72 is, for example, eight or fewer pieces per about 1 μm².

In the multilayer ceramic capacitor 1 of the second example embodiment, like in the multilayer ceramic capacitor 1 of the first example embodiment, a decrease in the mechanical strength of the multilayer ceramic capacitor 1 is reduced or prevented. Also, even if the length, in the lamination direction 100, of the outer layer portion 72 forming the ridgeline portion 60, i.e., the thickness of the outer layer portion 72, is about 35 μm or smaller, a decrease in the mechanical strength of the multilayer ceramic capacitor 1 is reduced or prevented.

### Method for Fabricating the Multilayer Ceramic Capacitor of the Second Example Embodiment

An example of a method for fabricating the multilayer ceramic capacitor 1 of the second example embodiment is described.
(1) A precursor of the ceramic base body 2 is prepared. Dielectric sheets for the ceramic base body 2 and a conductive paste for the internal electrode layers 30 are prepared. The dielectric sheets and the conductive paste for the internal electrode layers 30 include a binder and a solvent. The binder and the solvent may be an organic binder and an organic solvent that are publicly known.
(2) The conductive paste for the internal electrode layers 30 is applied on the dielectric sheets for printing in a predetermined pattern. As a result, an internal electrode layer pattern is formed on each dielectric sheet. Examples of the printing method include screen printing and gravure printing.
(3) A predetermined number of dielectric sheets on which no internal electrode layer pattern is printed are laminated. These laminated layers are layers including the outer layer portion 72 located on one side. On top of that, the dielectric sheets on which the internal electrode layer pattern is printed are sequentially laminated. These laminated layers are layers including e inner layer portion 70. On top of that, a predetermined number of dielectric sheets on which no internal electrode layer pattern is printed are laminated. These laminated layers are layers including the outer layer portion 72 located on the other side.
(4) The laminated sheets are pressed in the lamination direction and thus fabricated into a multilayer block. Isostatic press is an example of the pressing method.
(5) The multilayer block is cut into a multilayer chip. After that, through firing and the like, the ceramic base body 2 is formed. Specifically, the multilayer chip is subjected to a degreasing process in a nitrogen atmosphere under predetermined conditions. After that the multilayer chip is fired at a predetermined temperature in, for example, a mixed atmosphere of nitrogen, hydrogen, and steam, and the sintered ceramic base body 2 is thus obtained.

The conditions for the firing and the annealing process are the same or substantially the same as in the first example embodiment.
(6) After that, similar to the multilayer ceramic capacitor 1 of the first example embodiment, the terminal electrodes 50 are formed at the two end surfaces of the ceramic base body 2, namely the first base-body end surface 8 and the second base-body end surface 9. The multilayer ceramic capacitor is thus fabricated.

Although the present invention has been described using example embodiments, the present invention is not limited to the example embodiments described above and can be changed and modified variously.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including:
a first internal electrode layer and a second internal electrode layer alternately laminated with a dielectric layer including a ceramic dielectric interposed therebetween;
an active portion including:
a first active-portion main surface in a lamination direction;
a second active-portion main surface opposite from the first active-portion main surface;
a first active-portion side surface in a width direction and orthogonal or substantially orthogonal to the first active-portion main surface and the second active-portion main surface and from which the first internal electrode layer and the second internal electrode layer are extended;
a second active-portion side surface opposite from the first active-portion side surface and from which the first internal electrode layer and the second internal electrode layer are extended;
a first active-portion end surface in a length direction and orthogonal or substantially orthogonal to the first active-portion main surface, the second active-portion main surface, the first active-portion side surface, and the second active-portion side surface and from which the first internal electrode layer is extended; and
a second active-portion end surface opposite from the first active-portion end surface and from which the second internal electrode layer is extended;
inactive portions including a ceramic dielectric and covering the first active-portion main surface and the second active-portion main surface in the lamination direction; and
side margin portions covering the active portion and the inactive portions in the width direction;
a first terminal electrode covering the first active-portion end surface and electrically connected to the first internal electrode layer; and
a second terminal electrode covering the second active-portion end surface and electrically connected to the second internal electrode layer; wherein
the side margin portions define ridgeline portions;
the side margin portions include:
a first segregate including silicon as a main ingredient and having a longest dimension of about 10 nm or greater and about 50 nm or smaller; and
a plurality of second segregates each including silicon as a main ingredient and having a longest dimension of about 1 μm or greater.

2. The multilayer ceramic capacitor according to claim 1, wherein a ratio of existence of the first segregate is eight or fewer pieces per about 1 μm².

3. The multilayer ceramic capacitor according to claim 1, wherein the ceramic base body has a rectangular or substantially rectangular solid shape.

4. The multilayer ceramic capacitor according to claim 1, wherein each of the first and second internal electrode layers includes nickel, copper, silver, palladium, or gold or an alloy including at least one of nickel, copper, silver, palladium, or gold.

5. The multilayer ceramic capacitor according to claim 1, wherein a thickness of each of the first and second internal electrode layers is about 0.2 μm or greater and about 2.0 μm or smaller.

6. The multilayer ceramic capacitor according to claim 1, wherein the dielectric layer includes barium titanate, calcium titanate, strontium titanate, calcium zirconate, or strontium zirconate as a main ingredient.

7. The multilayer ceramic capacitor according to claim 6, wherein the dielectric layer includes a rare-earth oxide, a silicon compound, an aluminum compound, a magnesium compound, a manganese compound, an iron compound, a chromium compound, a cobalt compound, a vanadium compound, or a nickel compound as a an accessory ingredient.

8. The multilayer ceramic capacitor according to claim 1, wherein a thickness of the dielectric layer is about 0.3 μm or greater and about 10 μm or smaller.

9. The multilayer ceramic capacitor according to claim 1, wherein
a dimension of the ceramic base body in the length direction is about 0.2 mm or greater and about 10 mm or smaller;
a dimension of the ceramic base body in the width direction is about 0.1 mm or greater and about 5 mm or smaller; and
a dimension of the ceramic base body in the lamination direction is about 0.1 mm or greater and about 5 mm or smaller.

10. The multilayer ceramic capacitor according to claim 1, wherein each of the first and second terminal electrodes includes a foundation electrode layer, a nickel-plated layer on the foundation electrode layer, and a tin-plated layer on the nickel-plated layer.

11. A multilayer ceramic capacitor comprising:
a ceramic base body including:
a first internal electrode layer and a second internal electrode layer alternately laminated with a dielectric layer including a ceramic dielectric interposed therebetween;
an inner layer portion including:
a first inner-layer-portion main surface in a lamination direction;
a second inner-layer-portion main surface opposite from the first inner-layer-portion main surface;
a first inner-layer-portion side surface in a width direction and orthogonal or substantially orthogonal to the first inner-layer-portion main surface and the second inner-layer-portion main surface;
a second inner-layer-portion side surface opposite from the first inner-layer-portion side surface;
a first inner-layer-portion end surface in a length direction and orthogonal or substantially orthogonal to the first inner-layer-portion main surface, the second inner-layer-portion main surface, the first inner-layer-portion side surface, and the second inner-layer-portion side surface and from which the first internal electrode layer is extended; and
a second inner-layer-portion end surface opposite from the first inner-layer-portion end surface and from which the second internal electrode layer is extended;
outer layer portions including a ceramic dielectric and covering the first inner-layer-portion main surface and the second inner-layer-portion main surface in the lamination direction;
a first terminal electrode covering the first inner-layer-portion end surface and electrically connected to the first internal electrode layer; and
a second terminal electrode covering the second inner-layer-portion end surface and electrically connected to the second internal electrode layer; wherein
the outer layer portions define ridgeline portions;
the outer layer portions includes:
a first segregate including silicon as a main ingredient and having a longest dimension of about 10 nm or greater and about 50 nm or smaller; and
a plurality of second segregates each including silicon as a main ingredient and having a longest dimensions of about 1 μm or greater; and
a plurality of second segregates each being the second segregate.

12. The multilayer ceramic capacitor according to claim 11, wherein a ratio of existence of the first segregate is eight or fewer pieces per about 1 μm².

13. The multilayer ceramic capacitor according to claim 11, wherein the ceramic base body has a rectangular or substantially rectangular solid shape.

14. The multilayer ceramic capacitor according to claim 11, wherein each of the first and second internal electrode layers includes nickel, copper, silver, palladium, or gold or an alloy including at least one of nickel, copper, silver, palladium, or gold.

15. The multilayer ceramic capacitor according to claim 11, wherein a thickness of each of the first and second internal electrode layers is about 0.2 μm or greater and about 2.0 μm or smaller.

16. The multilayer ceramic capacitor according to claim 1, wherein the dielectric layer includes barium titanate, calcium titanate, strontium titanate, calcium zirconate, or strontium zirconate as a main ingredient.

17. The multilayer ceramic capacitor according to claim 16, wherein the dielectric layer includes a rare-earth oxide, a silicon compound, an aluminum compound, a magnesium compound, a manganese compound, an iron compound, a chromium compound, a cobalt compound, a vanadium compound, or a nickel compound as a an accessory ingredient.

18. The multilayer ceramic capacitor according to claim 11, wherein a thickness of the dielectric layer is about 0.3 μm or greater and about 10 μm or smaller.

19. The multilayer ceramic capacitor according to claim 11, wherein
a dimension of the ceramic base body in the length direction is about 0.2 mm or greater and about 10 mm or smaller;
a dimension of the ceramic base body in the width direction is about 0.1 mm or greater and about 5 mm or smaller; and
a dimension of the ceramic base body in the lamination direction is about 0.1 mm or greater and about 5 mm or smaller.

20. The multilayer ceramic capacitor according to claim 11, wherein each of the first and second terminal electrodes includes a foundation electrode layer, a nickel-plated layer on the foundation electrode layer, and a tin-plated layer on the nickel-plated layer.
